(19) United States
(12) Patent Application Publication
(10) Pub. No.: US 2022/0122080 A1
(43) Pub. Date: Apr. 21, 2022

(54) METHOD AND SYSTEM FOR DYNAMIC GOAL-BASED PLANNING AND LEARNING FOR SIMULATION OF ANOMALOUS ACTIVITIES

(71) Applicant: JPMorgan Chase Bank, N.A., New York, NY (US)

(72) Inventors: Daniel BORRAJO, Pozuelo de Alarcon (ES); Maria Manuela VELOSO, New York, NY (US); Sameena SHAH, Scarsdale, NY (US)

(73) Assignee: JPMorgan Chase Bank, N.A., New York, NY (US)

(21) Appl. No.: 17/450,733

(22) Filed: Oct. 13, 2021

Related U.S. Application Data
(60) Provisional application No. 63/092,231, filed on Oct. 15, 2020.

(51) Int. Cl. G06Q 20/40; G06F 16/28; G06N 20/00

(52) U.S. Cl. CPC G06Q 20/4016; G06K 9/00335; G06N 20/00; G06F 16/285

(57) ABSTRACT

A method for detecting an anomaly in human behavior is provided. The method includes: receiving information that relates to a behavior of a person; determining at least one behavior trace based on the received information; classifying each behavior trace into a respective category from among a first category that corresponds to behaviors that indicate an intention to commit a crime, such as money laundering, and a second category that corresponds to behaviors that indicate standard non-criminal activity; and analyzing each behavior trace to determine a potential intended goal of the person. The behavior trace includes a sequence of behavioral states and actions performed by the person in response to each respective behavioral state.

### CROSS-REFERENCE TO RELATED APPLICATIONS

This application claims the benefit from U.S. Provisional Application No. 63/092,231, filed Oct. 15, 2020, which is hereby incorporated by reference in its entirety.

### BACKGROUND

### 1. Field of the Disclosure

This technology generally relates to methods and systems for detecting anomalous behavior, and more particularly to methods and systems for dynamic goal-based planning and learning for simulation of anomalous activities.

### 2. Background Information

Adversarial settings are common in many business domains, where both sides adapt their strategies over time. For example, money laundering vs Anti-Money Laundering (AML), or those in fraud, and cyber-crime. Regarding AML, a key characteristic is the wide range of strategies that are available to a money launderer, who may come up with completely novel, previously unseen strategies to evade authorities. At present, models available to investigators involve playing catch-up. Investigators may happen to detect a new typology used by a money launderer and may make recommendations to put in new controls for the novel typology detected. Subsequently, the organization may adjust its models to counter the newly observed strategy to allow its detection going forward. However, significant delay and crime might have passed through by the time new controls are put in place. Money launderers, fraudsters, or other bad actors often remove and obscure the funds (i.e., benefits) from the networks to nullify their risk of any future cease of funds, in case of any retrospective action by authorities. Hence, timely detection of previously unseen typologies is of utmost importance.

Over time, financial institutions have been mandated by law enforcement agencies to improve their processes to detect suspicious activity and raise the corresponding Suspicious Activity Reports (SARs). A typical prevalent AML model starts by observing transactions, public media, or a referral, and generates alerts. Then, alerts are investigated by humans who decide whether they need to report a SAR to law enforcement for the alert. Since there is a bias towards being conservative and raising alerts at the detection of any suspicious behavior, many alerts are generated and the manual effort put into investigations is enormous. However, despite all these efforts, most of the money laundering activities are not noticed in time.

In order to provide efficient artificial intelligence (AI) tools to help human investigators and law enforcement, any investigation needs to provide a rationale for its decisions, as filing a SAR. Such a rationale often entails gathering all applicable sets of evidences via a sequence of steps and a final assessment of all evidences. Mostly, applicable evidences deal with inferring the goals of a subject. Therefore, in order to be used in practice, the output of any AI-based system that tackles this task should explicitly mention the goals the suspects were pursuing, as well as the actions the subjects of interest carried out and the evidences that led to that conclusion.

Previous work on automating AML has defined sets of rules to detect particular behaviors, or applied machine learning to transactions or social networks. Most of these recent works use neural network (NN) based approaches. These approaches have shown exceptional performance for many tasks including image classification or natural language processing. But, given their current way of handling explanations, they are not yet a viable solution from a practical perspective. Instead, symbolic approaches are clearly much better suited for tasks requiring explanations. Other approaches have used a variety of AI techniques to solve the AML classification task, such as support vector machines (SVMs), Dynamic Bayesian Networks and clustering, radial basis function (RBF) neural networks, fuzzy logic, association rules and frequent set analysis, clustering, or decision trees. The AML task can also be posed as anomalies or outliers detection where the techniques and representation formalisms are also based on attribute-value.

Accordingly, there is a need for a mechanism for dynamic goal-based planning and learning for simulation of anomalous banking activities, such as money laundering, fraud, and cyber-crime.

### SUMMARY

The present disclosure, through one or more of its various aspects, embodiments, and/or specific features or sub-components, provides, inter alia, various systems, servers, devices, methods, media, programs, and platforms for dynamic goal-based planning and learning for simulation of anomalous banking activities.

According to an aspect of the present disclosure, a method for detecting an anomaly in human behavior is provided. The method is implemented by at least one processor. The method includes: receiving, by the at least one processor, information that relates to a behavior of a person; determining, by the at least one processor, at least one behavior trace based on the received information; and classifying, by the at least one processor, each of the determined at least one behavior trace into a respective category from among a predetermined plurality of behavioral categories. The at least one behavior trace includes a sequence of behavioral states and actions performed by the person in response to each respective behavioral state.

The information that relates to the behavior of the person may include information that relates to at least one financial transaction executed by the person.

The determining of the at least one behavior trace may include applying a relational instance-based learning algorithm to the received information and obtaining information that indicates the at least one behavior trace as an output of the relational instance-based learning algorithm.

The classifying may include using at least one machine learning algorithm to compare the determined at least one behavior trace with historical behavior trace data to determine the respective category.

The predetermined plurality of behavioral categories may include a first category that corresponds to behaviors that indicate an intention to commit a crime and a second category that corresponds to behaviors that indicate standard non-criminal activity.

The method may further include analyzing each of the determined at least one behavior trace to determine a potential intended goal of the person. The analyzing may include determining whether the determined at least one behavior trace indicates an increased probability of behavior that includes a financial crime, such as, for example, a money laundering crime, a fraud, and/or a cyber-crime.

According to another aspect of the present disclosure, a computing apparatus for detecting an anomaly in human behavior is provided. The computing apparatus includes a processor; a memory; and a communication interface coupled to each of the processor and the memory. The processor is configured to: receive, via the communication interface, information that relates to a behavior of a person; determine at least one behavior trace based on the received information; and classify each of the determined at least one behavior trace into a respective category from among a predetermined plurality of behavioral categories. The at least one behavior trace includes a sequence of behavioral states and actions performed by the person in response to each respective behavioral state.

The information that relates to the behavior of the person may include information that relates to at least one financial transaction executed by the person.

The processor may be further configured to determine the at least one behavior trace by applying a relational instance-based learning algorithm to the received information and obtaining information that indicates the at least one behavior trace as an output of the relational instance-based learning algorithm.

The processor may be further configured to use at least one machine learning algorithm to compare the determined at least one behavior trace with historical behavior trace data to determine the respective category.

The predetermined plurality of behavioral categories may include a first category that corresponds to behaviors that indicate an intention to commit a crime and a second category that corresponds to behaviors that indicate standard non-criminal activity.

The processor may be further configured to analyze each of the determined at least one behavior trace to determine a potential intended goal of the person.

The processor may be further configured to determine whether the determined at least one behavior trace indicates an increased probability of behavior that includes a financial crime, such as, for example, a money laundering crime, a fraud, and/or a cyber-crime.

According to yet another aspect of the present disclosure, a non-transitory computer readable storage medium storing instructions for detecting an anomaly in human behavior is provided. The storage medium includes executable code which, when executed by a processor, causes the processor to: receive information that relates to a behavior of a person; determine at least one behavior trace based on the received information; and classify each of the determined at least one behavior trace into a respective category from among a predetermined plurality of behavioral categories. The at least one behavior trace includes a sequence of behavioral states and actions performed by the person in response to each respective behavioral state.

The information that relates to the behavior of the person may include information that relates to at least one financial transaction executed by the person.

The executable code may be further configured to cause the processor to apply a relational instance-based learning algorithm to the received information and obtain information that indicates the at least one behavior trace as an output of the relational instance-based learning algorithm.

The executable code may be further configured to cause the processor to analyze each of the determined at least one behavior trace to determine a potential intended goal of the person.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for dynamic goal-based planning and learning for simulation of anomalous activities.

FIG. 4 is a flowchart of an exemplary process for implementing a method for dynamic goal-based planning and learning for simulation of anomalous activities.

FIG. 5 is a block diagram of a simulator configured to implement a method for dynamic goal-based planning and learning for simulation of anomalous activities, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

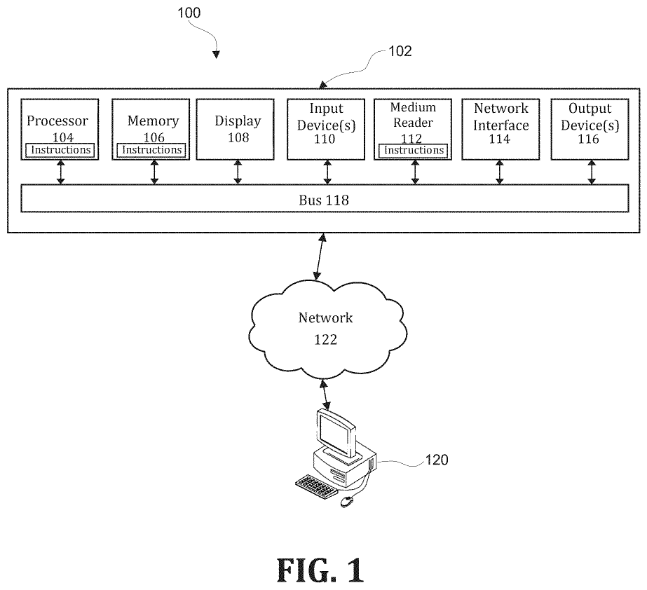

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for dynamic goal-based planning and learning for simulation of anomalous activities.

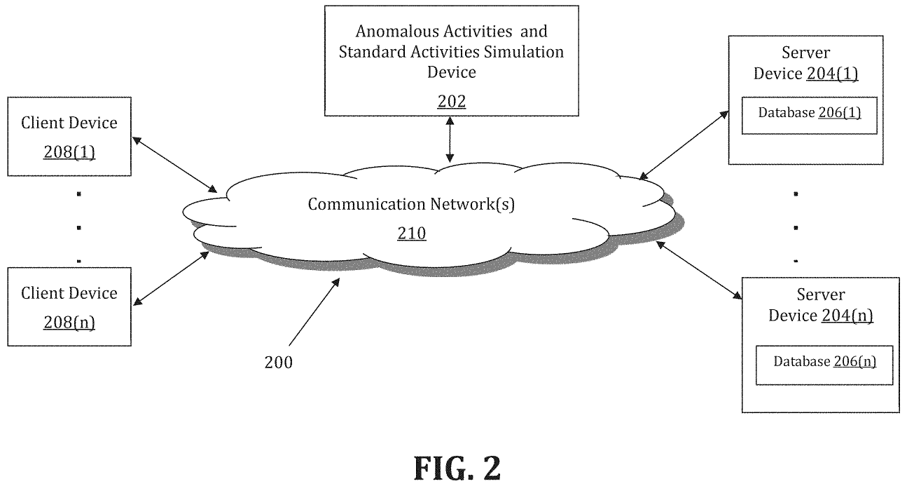

Referring to FIG. 2, a schematic of an exemplary network environment 200 for implementing a method for dynamic goal-based planning and learning for simulation of anomalous activities is illustrated. In an exemplary embodiment, the method is executable on any networked computer platform, such as, for example, a personal computer (PC).

The method for dynamic goal-based planning and learning for simulation of anomalous activities may be implemented by a Human Behavioral Activities Simulation (HBAS) device 202. The HBAS device 202 may be the same or similar to the computer system 102 as described with respect to FIG. 1. The HBAS device 202 may store one or more applications that can include executable instructions that, when executed by the HBAS device 202, cause the HBAS device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the HBAS device 202 itself, may be located in virtual server(s) running in a cloud-based computing environment rather than being tied to one or more specific physical network computing devices. Also, the application(s) may be running in one or more virtual machines (VMs) executing on the HBAS device 202. Additionally, in one or more embodiments of this technology, virtual machine(s) running on the HBAS device 202 may be managed or supervised by a hypervisor.

In the network environment 200 of FIG. 2, the HBAS device 202 is coupled to a plurality of server devices 204(1)-204(n) that hosts a plurality of databases 206(1)-206(n), and also to a plurality of client devices 208(1)-208(n) via communication network(s) 210. A communication interface of the HBAS device 202, such as the network interface 114 of the computer system 102 of FIG. 1, operatively couples and communicates between the HBAS device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the HBAS device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and HBAS devices that efficiently implement a method for dynamic goal-based planning and learning for simulation of anomalous activities.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The HBAS device 202 may be a standalone device or integrated with one or more other devices or apparatuses, such as one or more of the server devices 204(1)-204(n), for example. In one particular example, the HBAS device 202 may include or be hosted by one of the server devices 204(1)-204(n), and other arrangements are also possible. Moreover, one or more of the devices of the HBAS device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the HBAS device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store historical transaction data and data that relates to simulation parameters and results.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the HBAS device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the HBAS device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the HBAS device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the HBAS device 202, the server devices 204(1)-204(n), or the client devices 208(1)-208(n), for example, may be configured to operate as virtual instances on the same physical machine. In other words, one or more of the HBAS device 202, the server devices 204(1)-204(n), or the client devices 208(1)-208(n) may operate on the same physical device rather than as separate devices communicating through communication network(s) 210. Additionally, there may be more or fewer HBAS devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

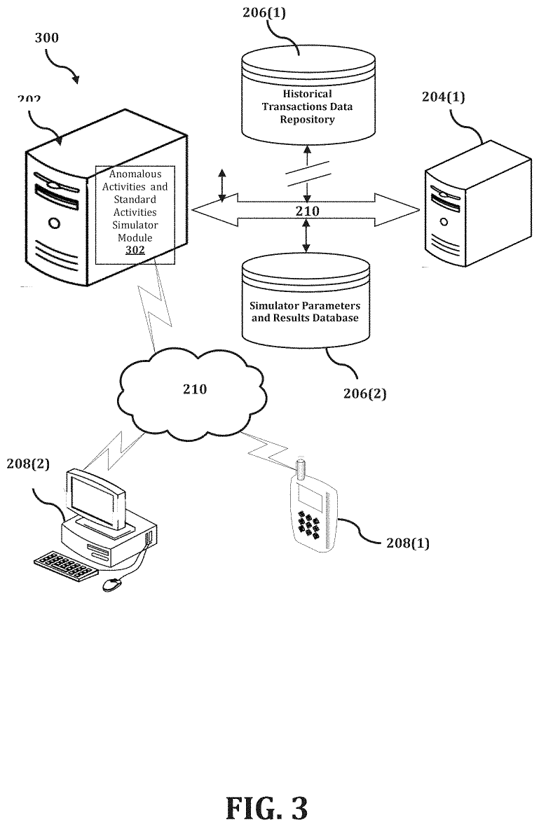

The HBAS device 202 is described and illustrated in FIG. 3 as including human behavioral activities simulation module 302, although it may include other rules, policies, modules, databases, or applications, for example. As will be described below, the human behavioral activities simulation module 302 is configured to implement a method for dynamic goal-based planning and learning for simulation of anomalous activities.

An exemplary process 300 for implementing a mechanism for dynamic goal-based planning and learning for simulation of anomalous activities by utilizing the network environment of FIG. 2 is illustrated as being executed in FIG. 3. Specifically, a first client device 208(1) and a second client device 208(2) are illustrated as being in communication with HBAS device 202. In this regard, the first client device 208(1) and the second client device 208(2) may be “clients” of the HBAS device 202 and are described herein as such. Nevertheless, it is to be known and understood that the first client device 208(1) and/or the second client device 208(2) need not necessarily be “clients” of the HBAS device 202, or any entity described in association therewith herein. Any additional or alternative relationship may exist between either or both of the first client device 208(1) and the second client device 208(2) and the HBAS device 202, or no relationship may exist.

Further, HBAS device 202 is illustrated as being able to access a historical transactions data repository 206(1) and a simulator parameters and results database 206(2). The human behavioral activities simulator module 302 may be configured to access these databases for implementing a method for dynamic goal-based planning and learning for simulation of anomalous activities.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the HBAS device 202 via broadband or cellular communication. Of course, these embodiments are merely exemplary and are not limiting or exhaustive.

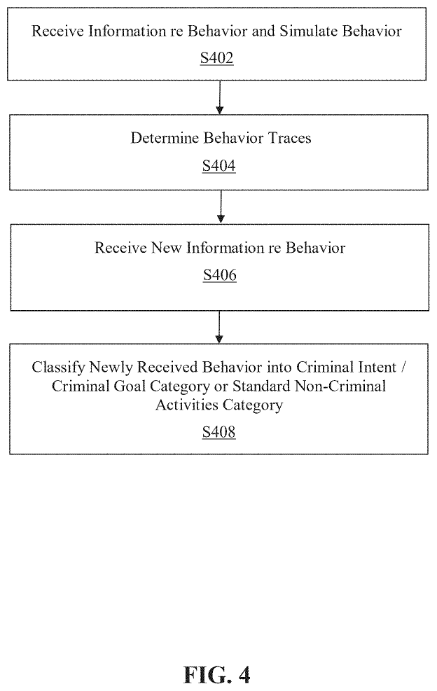

Upon being started, the human behavioral activities simulator module 302 executes a process for dynamic goal-based planning and learning for simulation of anomalous activities. An exemplary process for dynamic goal-based planning and learning for simulation of anomalous activities is generally indicated at flowchart 400 in FIG. 4.

In process 400 of FIG. 4, at step S402, the human behavioral activities simulator module 302 receives information that relates to a behavior of a person and then generates a simulation of that behavior. In an exemplary embodiment, the information may include information that relates to at least one financial transaction executed by the person.

At step S404, the human behavioral activities simulator module 302 determines at least one behavior trace based on the information received in step S402. In an exemplary embodiment, a behavior trace is a sequence of behavioral states and actions performed by person in response to each respective behavioral state. In an exemplary embodiment, the determination of the behavior trace may be implemented by applying a relational instance-based learning algorithm to the received information that relates to the behavior of the person and obtaining information that indicates the behavior trace as an output of the relational instance-based learning algorithm.

At step S406, the human behavioral activities simulator module 302 receives new information about the behavior of the person. Then, at step S408, the human behavioral activities simulator module 302 classifies the newly received behavior trace into a category that is selected from among a predetermined plurality of behavioral categories. In an exemplary embodiment, the predetermined plurality of behavioral categories may include a first category that corresponds to behaviors that indicate an intention to commit a crime and a second category that corresponds to behaviors that indicate standard non-criminal activity. In an exemplary embodiment, the classification of the behavior trace into a category may be implemented by using a machine learning algorithm to compare the behavior with historical behavior trace data in order to determine the correct category. For example, the classification may include determining whether the behavior trace indicates an increased probability of behavior that includes a financial crime, such as, for example, a money laundering crime, a fraud, and/or a cyber-crime.

In an exemplary embodiment, it may be assumed that there is a rationale for the behavior of agents (i.e., customers) when taking actions in the environment that is partially observable by a financial institution, such as a bank. This behavior depends on some hidden human goals and the states they encounter while taking actions to achieve those goals. It may also be assumed that goals, states and actions can be represented using a form of high-level representation formalism, such as predicate logic. These assumptions are in line with the need to file a rationale for each Suspicious Activity Report (SAR). The evidences compiled in SARs correspond to descriptions of actions (i.e., activities) taken by suspicious persons (e.g., several cash deposits) and the corresponding states (e.g., network of people and companies). While all this knowledge could potentially be represented in the attribute-value representation used by most other artificial intelligence (AI) techniques applied to anti-money laundering (AML), in an exemplary embodiment, the size of the representation must be constrained, some extensive domain-dependent feature engineering is required, or representation power will be lost.

Given those assumptions, the problem of AML may be posed as a relational classification task. It takes as input a trace of human behavior corresponding to the execution of observable actions by the financial institution and the corresponding observable components of states. It generates as output a decision of whether that trace corresponds to money laundering or not. In an exemplary embodiment, a learning system may be trained with previous traces of known behavior (i.e., both money laundering or not), which can be trivially extracted from current information systems of financial institutions in a relational format. In an exemplary embodiment, the learning system may be labeled as Classification of Agents' Behavior Based on Observation Traces (CABBOT).

In an exemplary embodiment, the present disclosure provides a new enhanced model of human behavior in the context of financial institutions based on states and actions; a learning technique that can classify in agents' (or behavior) types based on observation traces; and a simulator of agents' behavior based on dynamic goal generation, planning and execution. Since most available datasets on AML correspond to only transactions data, the simulator generates realistic traces of these kinds of behavior and incorporates a rich representation of actions and states.

States and Actions Traces: In an exemplary embodiment, it is assumed that agents' rational behavior is based on the concepts of goals, states and actions. In order to establish a common representation language, a form of predicate logic is used to represent the information that an agent (such as a financial institution), F, can observe from the behavior of another agent (e.g. customer), C. States are represented as sets of literals, where literals can be predicates or functions. Predicates have a name and a list of arguments (e.g. account-owner(c1,acc1)). Functions represent numeric variables and are composed of a name, its arguments and the value (e.g. balance(acc1)=12020). As in the real world, part of the state is observable by F and another part is not observable. For instance, the owner of an account will be observable by a financial institution, while the fact that someone is trying to launder money will not be observable.

Representation of States and Goals: Tables 1 and 2 include lists of key predicates and functions. They can refer to four categories of information: 1) transaction-based; 2) relationship-based, related to the network of people or companies connected to each customer; 3) both kinds, transaction and network; or 4) to the bank, but not related to network or transactions. The tables also represent their observability.

TABLE 1
List of predicates, their observability and the type of
information they refer to in case they are observable.

| Predicate | Observable | Type |
|---|---|---|
| money-laundering | no | |
| money-laundered | no | |
| has-dirty-money | no | |
| criminal | no | |
| banned-country | yes | network |
| account-owner | yes | network |
| account-country | yes | network |
| member-of | yes | network |
| bill-due | yes | network |
| owes-money | no | |
| employed | yes | network |
| works-for | yes | network |
| has-company | yes | network |
| transaction-origin | yes | transactions |
| transaction-destination | yes | transactions |
| received-payroll | yes | both |
| has-card | yes | bank |
| enjoyed-service | no | |
| provides-service | no | |
| owns | no | |

TABLE 2
List of functions, their observability and the type of
information they refer to in case they are observable.

| Function | Observable | Type |
|---|---|---|
| balance | yes | both |
| transaction-amount | yes | transactions |
| dirty-money | no | |
| criminal-income | no | |
| working-day | no | |
| days-without-pay | no | |
| salary | no | |
| price | no | |
| owed-money | no | |

Representation of Actions: Table 3 below lists key actions, together with the same data as in the case of predicates. Some of these actions are duplicated, since they can be used by standard customers or criminals. F will observe criminals' actions as their corresponding standard ones. For instance, integration-cash-out represents a withdrawal following money laundering, but F will observe it as a cash-out action.

TABLE 3
List of actions, their observability and the type of information
they refer to in case they are observable.

| Action | Observable | Type |
|---|---|---|
| create-company | no | |
| associate | no | |
| create-account | yes | network |
| set-ownership-account | yes | network |
| perform-criminal-action | no | |
| finish-money-laundering | no | |
| takes-job | no | |
| work | no | |
| payroll | yes | both |
| quick-deposit | yes | transactions |
| placement-cash-in | yes | transactions |
| digital-deposit | yes | transactions |
| placement-digital | yes | transactions |
| buy-digital | no | |
| cash-out | yes | transactions |
| integration-cash-out | yes | transactions |
| pay-bill | yes | both |
| create-bill | no | |
| integration-pay-bill | yes | both |
| move-funds | yes | transactions |
| move-funds-internationally | yes | transactions |
| move-funds-self | yes | transactions |
| layering | no | |
| quick-payment | yes | transactions |
| buy-direct | yes | transactions |
| placement-buy-direct | yes | transactions |
| enjoy-service | yes | transactions |
| placement-enjoyed-service | yes | transactions |

Traces of Behavior: In an exemplary embodiment, the learning system takes as input traces of observable behavior. A trace t_{C} is a sequence of states and actions executed by C in those states: t_{C}=(s₀,a₁,s₁,a₂,s₂, . . . , sₙ₋₁,aₙ,sₙ), where sᵢ is a state and aᵢ is an action name and its parameters. States and actions correspond to the observable predicates and actions from the viewpoint of F. T_{C}={t_{C}} refers to the set of traces observed from C.

It is assumed that there is nothing in the observable state that directly identifies one or the other type of behavior. There is also no difference on the observable actions between those that can be executed by one or the other type of C.

Learning to Classify Behavior: F's task consists of learning to classify among the different types of C (behaviors).

Learning Task: The learning task can be defined as follows. Given: N classes of behavior, (e.g., {good, bad}); and a set of labeled observed traces, T_{C}_{ᵢ},∀Cᵢ∈{good, bad}; Obtain: a classifier that takes as input a new (partial) trace t (with unknown class) and outputs the predicted class.

A characteristic of this learning task is that it works on unbounded size of the learning examples. Traces can be arbitrarily large. Also, states within the trace and action descriptions can be arbitrarily large, both in the number of different action schemas, and in the number of grounded actions. Using fixed-sized input learning techniques can be difficult in these cases and some assumptions are made to handle that characteristic. Therefore, only relational learning techniques are considered, and, in particular, relational instance-based approaches.

In an exemplary embodiment, a relational k Nearest Neighbor (kNN) algorithm, e.g., a relational instance-based learning (RIBL) algorithm, may be used to classify a new trace according to the k traces with minimum distance, and then the mode of those traces' classes may be computed. Since the classifier takes a trace as input, CABBOT allows for on-line classification with the current trace up to a given execution step. A nice property of kNN is that an explanation as to how a behavior was classified may be obtained by pointing out the closest previous cases and which are the most similar components (actions and states) of the closest traces.

Distance Functions between Traces: In an exemplary embodiment, the key parameter of the relational learning techniques to be used is the distance between two traces, d:T×T→R. Similarity functions have been extensively studied. Four distance metrics are defined herein that can deal with state-action traces: actions; state differences; n-grams; and relational.

Distance based on Actions: A simple, yet effective, distance function consists of using the inverse of the Jaccard similarity function as:

$${d}_{a} ( {t}_{1} , {t}_{2} ) = 1 - \frac{\vert an ( {t}_{1} ) ⋂ an ( {t}_{2} ) \vert}{\vert an ( {t}_{1} ) ⋃ an ( {t}_{2} ) \vert}$$

where an(tᵢ) is the set of actions names in tᵢ. This distance is based on the ratio of common action names in both traces to the total number of different action names in both traces.

Distance based on State Differences: Given two consecutive states s₁ and s₂ in a trace, their associated difference or delta may be defined as δₛ_{ᵢ}_{,s}_{ᵢ₊₁}=sᵢ₊₁\sᵢ. These deltas represent the new literals in the state after applying the action. A distance between the sets of deltas on each trace may be computed by using the Jaccard similarity function as before.

$${d}_{Δ} ( {t}_{1} , {t}_{2} ) = 1 - \frac{\vert Δ ( {t}_{1} ) ⋂ Δ ( {t}_{2} ) \vert}{\vert Δ ( {t}_{1} ) ⋃ Δ ( {t}_{2} ) \vert}$$

where Δ(tᵢ) is the set of deltas of a trace tᵢ. Again, only the predicate and function names are used.

Distance based on n-grams: The two previous distances only consider actions and deltas as sets. If it is desired to improve the distance metric, a frequency-based approach (i.e., equivalent to an n-grams analysis with n=1) may be used. Each trace is represented by a vector. Each position of the vector contains the number of times an observable action appears in the trace. The distance between two traces, d_{g}, is defined as the squared Euclidean distance of the vectors representing the traces. As before, a new trace is classified as the class of the training trace with the minimum distance to the new trace.

Relational-based Distance: Instead of using only counts, the distance function can also consider action and state changes as relational formulae and use more powerful relational distance metrics. In an exemplary embodiment, a version of the RIBL distance function may be adapted to a representation of traces, dᵣ. It may be modified given the different semantics of the elements of the traces with respect to generic RIBL of examples. Given two traces, the traces are first normalized by substitution of the constants' names by an index of the first time they appeared within a trace. For instance, given the following action and state:

```
[  create-account(customer-234, acc-345),
    { acc-owner(customer 234, acc-345)
    balance(acc-345)=2000}], create-account(customer-234,acc-
                          345),
      { acc-owner(customer-
                                    234,acc-345)
      balance(acc-
      345)=2000} [symbol]   ,
  the normalization process would convert the trace to:
  [  create-account(i1, i2),
    {acc- create-account(i1,i2),
owner(i1, i2), balance(i2)=2000}]
              {acc-
                owner(i1,i2),balance(i2)=2000} [symbol]
```

This process allows the distance metric to partially remove the issue related to using different constant names in the traces. The distance dᵣ is then computed as:

dᵣ(t₁,t₂)=½(dᵣₐ(t₁,t₂)+d_{rΔ}(t₁,t₂)),

i.e., as the average of the sum of dᵣₐ (distance between the actions of the two traces) and d_{rΔ} (distance between the deltas of both traces). dᵣₐ is computed as:

$${d}_{ra} ( {t}_{1} , {t}_{2} ) = \frac{1}{Z} {\sum }_{{a}_{i} ∈ a ( {t}_{1} )} {min}_{{a}_{j} ∈ a ( {t}_{2} )} {d}_{f} ( {a}_{i} , {a}_{j} )$$

where a(tᵢ) is the set of ground actions in tᵢ, d_{ƒ} is the distance between two relational formulae and Z is a normalization factor (Z=max{|a(t₁)|,|a(t₂)|}). This is normalized by using the length of the longest set of actions to obtain a value that does not depend on the number of actions on each set, so distances are always between 0 and 1. d_{ƒ} is 1 if the names of aᵢ and aⱼ differ. Otherwise, it is computed as:

$${d}_{f} ( {a}_{i} , {a}_{j} ) = 0.5 - 0.5 \frac{1}{\vert arg ( {a}_{i} ) \vert} {d}_{arg} ( {a}_{i} , {a}_{j} )$$

where d_{arg}(aᵢ,aⱼ) is the sum of the distances between the arguments in the same positions in both actions. Each distance will be zero (0) if they are the same constant and one (1) otherwise. Again, the values for distances are normalized. Also, when two grounded actions have the same action name, a distance of at most 0.5 is set. For instance, if l₁=create-account(i1,i2) and l₂=create-account(i3,i2),

d_{ƒ}(l₁,l₂)=0.5−0.5½(1+0)=0.25.

As a reminder, each trace contains a sequence of sets of literals that correspond to the delta of two states. Therefore, d_{rΔ} is computed as the distance of two sets of deltas of literals (Δ(t₁) and Δ(t₂)). This may be computed in a similar way as in the previous formulas:

$${d}_{r Δ} ( {t}_{1} , {t}_{2} ) = \frac{1}{{Z}_{Δ}} {\sum }_{{δ}_{1} ∈ Δ ( {t}_{1} )} {min}_{{δ}_{2} ∈ ( {t}_{2} )} {d}_{r δ} ( {δ}_{1} , {δ}_{2} )$$

$$where {Z}_{Δ} = max \{ \vert Δ ( {t}_{1} ) \vert , \vert Δ ( {t}_{2} ) \vert \} , and {d}_{r δ} : \\ {d}_{r δ} ( {δ}_{1} , {δ}_{2} ) = \frac{1}{max \{ \vert {δ}_{1} \vert , \vert {δ}_{2} \vert \}} {\sum }_{li ∈ δ 1} {min}_{lj ∈ δ 2} {d}_{f} , ( {l}_{i} , {l}_{j} )$$

d_{ƒ′}(lᵢ,lⱼ)=d_{ƒ}(lᵢ,lⱼ) when the literals correspond to predicates. d_{ƒ} is used since actions and literals in the state (lⱼ,lⱼ) share the same format (i.e., a name and some arguments). However, when they correspond to functions, since functions have numerical values, a different function dₙ may be used. In this case, each lᵢ will have the form ƒᵢ(argᵢ)=νᵢ. ƒ(argᵢ) has the same format as a predicate (or action) with a name ƒᵢ and a set of arguments argᵢ, so d_{ƒ} may be used on that part. The second part is the functions' value. In this case, the absolute value of the difference between the numerical values of both functions is computed and then divided by the maximum possible difference (M) to normalize:

$${d}_{n} ( {l}_{i} , {l}_{j} ) = {d}_{f} ( {f}_{i} ( {arg}_{i} ) {f}_{j} ( {arg}_{j} ) ) \times \frac{abs ( {v}_{i} - {v}_{j} )}{M}$$

In an exemplary embodiment, both formulae are multiplied, since the distance on the arguments may be understood as a weight that modifies the difference in numerical values. For example, if

$${δ}_{1} = \{ acc \text{-} owner ( i 1 , i 2 ) , balance ( i 2 ) = 20 \} , \\ {δ}_{2} = \{ acc \text{-} owner ( i 1 , i 3 ) , balance ( i 3 ) = 10 \} , then$$

$${d}_{r Δ} ( {δ}_{1} , {δ}_{2} ) = \frac{1}{2} ( min \{ 0.25 , 1 \} + min \{ 1 , 0.5 \times \frac{\vert 20 - 10 \vert}{M} \} )$$

Experiments and Results: 10 training traces of each type of behavior (good and bad) have been generated using the simulator described below. Experiments have been performed using a higher number of training traces and also generating an unbalanced training set where the good traces outnumber by a large margin the bad traces, as is the case in a conventional AML investigation. It is observed that if a small number of training traces represent the prototypical traces of each class, kNN approaches can obtain good accuracy even in the unbalanced case. The traces were synthetically generated since there is no other available dataset that includes real data, apart from some transaction-based simulators. Since the simulator can handle richer representation models than just transactional data, these other datasets were of limited use. For evaluation, 20 new test traces have been generated that are randomly sampled from the two types of behavior. At each step in the test traces, the classifier is used to predict the class of the new trace. The accuracy of the prediction is reported at the end of each test case, as well as how many observations, in average, the classifier needed in order to generate the final decision (i.e., whether it was the correct or incorrect one). A value of k=1 is used for the experiments, given that good results have previously been obtained. Results were equivalent for other values of k.

Observability Models and Distances: Tables 4 and 5 depict the effect of different observability models (rows) in combination with different distance functions (columns); i.e. dₐ, action-based, d_{Δ}, state difference, d_{g}, i-grams, and dᵣ, relational. The following are used as observability models: full (i.e., F can observe all actions and literals), bank (i.e., it can only observe the literals/actions related to information that is provided by C to F), network (i.e., it can only observe from the bank model, data related to the relations of C with other actors—customers or companies), transactions (i.e., it can only observe from the bank model transaction-based information), and two more which are described below. Since on-line classification is being performed, the values in Table 4 reflect the average number of pairs action/state that F had to observe before it made the final classification. Table 5 shows the accuracy at the end of the trace.

TABLE 4
Average number of observations before making the final classification
decision when varying the observable part of the model and the distance
function using kNN. Columns represent the distance functions: dₐ,
action-based; d_{Δ}, state difference; d_{g} n-grams, and dᵣ, relational.

| | |
|---|---|
| Observability | Avg. # observations |

| Model | d_{Δ} | dₐ | d_{g} | dᵣ |
|---|---|---|---|---|
| Full | 0.50 | 0.50 | 9.0 | 0.6 |
| bank | 2.00 | 3.50 | 5.6 | 1.0 |
| network | 2.20 | 3.70 | 3.55 | 4.3 |
| transactions | 7.75 | 14.65 | 14.5 | 5.5 |
| no-companies | 6.05 | 15.70 | 18.4 | 2.6 |
| limited | 9.70 | 28.00 | 13.2 | 1.6 |

It is concluded that the more information is observable by F, the faster the right classification is made. In the case of providing full information, i.e., the unrealistic case where the financial institution can observe all predicates and actions, it converges very fast to the right decision. After only one step, it commits to the right decision (i.e., perfect accuracy) since it sees all the information, including whether someone is a criminal. In case of only observing transactions data, it takes more time to converge than using only network information, since network data (i.e., opening accounts, being part of companies, etc.) is observed before customers start making transactions. Another observation is that using the delta-distance provides better results than using actions-distance. This is expected as information on the states is more diverse between the two types of behavior than the information on actions. States contain more knowledge than just what appears in actions' names and parameters. Also, given two consecutive states, the effects of the corresponding action can be inferred, providing more information than just the name and parameters.

TABLE 5
Accuracy when varying the observable part of the
model and the distance function using kNN. The columns
represent the same distances as in Table 4.

| | |
|---|---|
| Observability | Accuracy (%) |

| model | d_{Δ} | dₐ | d_{g} | dᵣ |
|---|---|---|---|---|
| full | 100 | 100 | 100 | 100 |
| bank | 100 | 100 | 100 | 100 |
| network | 100 | 100 | 100 | 100 |
| transactions | 100 | 100 | 90 | 100 |
| no-companies | 100 | 85 | 100 | 100 |
| limited | 100 | 65 | 95 | 100 |

In most cases, the accuracy was perfect (100%), so all test traces were correctly classified. Even if extreme care was taken on making the initial information and the actions taken by both kinds of behavior equal, CABBOT was able to detect unintended differences in the traces. For instance, in the case of criminals, they create companies while that option was not available for standard customers. To test the hypothesis that this provided an advantage to the network based observability, those actions could be included for regular customers. Instead, a new observability type, no-companies, was created, where F could observe the same information as in the bank observability, except for any company related information, such as predicate member-of or action set-ownership-account. Table 4 shows that in that case the performance is close to that of only using transactions.

Another example of the differences between the two kinds of behavior relates to money withdrawals that were used by criminals while they were not used by regular customers or using digital currency. So, another observability model was created, named limited, where F could not observe the companies related information, the withdrawals nor the operations with digital currency. In that case, it affects actions cash-out, integration-cash-out, digital-deposit, placement-digital and buy-digital. The table shows the results, which obviously are worse than the other observation models. Also, in the case of using actions-distance, the accuracy of these two last observation models dropped to 85% and 65%, respectively. In relation to the distance functions defined, the accuracy is similar in most cases, but the time it takes them to converge to the right classification varies from the simplest ones, dₐ and d_{Δ} to the most elaborated one, dᵣ. Using this last distance function, it needs very few examples to make the right decision.

Traces Length and Goals Probability: In the previous experiment, a length of the trace was fixed to be 50. The second experiment aims at analyzing the effect of the length of traces (simulation horizon) in the accuracy, fixing the observation model to bank and the distance metric to dᵣ. Again, a perfect accuracy was obtained starting with traces of length 5, given that the creation of companies was performed in the early stages. Since these results depend on how often a customer performs actions, the probability of new goals being generated was changed in a simulation step. This probability affects how often a customer performs actions, as further described below. That probability was varied and checked against different horizons. Results are shown in Table 6. It may be observed that if the probability of a goal appearing in a given step decreases, the accuracy also decreases, since less observations are made by F. If the trace is short or the probability of a goal appearing is small, there is less space for CABBOT to detect bad/good behavior. So, it becomes equivalent to a random decision. For instance, when the probability is 0.01, a goal will only appear once every 100 steps, so the classification will be based on no information.

TABLE 6
Classification accuracy when varying the traces length and the
probability a goal appears at a given time step.

| | Length of traces | | | | | |
|---|---|---|---|---|---|---|
| Prob. goal | 1 | 5 | 10 | 20 | 50 | 100 |
| 1.0 | 80 | 100 | 100 | 100 | 100 | 100 |
| 0.8 | 60 | 100 | 100 | 100 | 100 | 100 |
| 0.5 | 50 | 70 | 100 | 100 | 100 | 100 |
| 0.2 | 60 | 55 | 75 | 100 | 100 | 100 |
| 0.1 | 60 | 60 | 70 | 80 | 95 | 100 |
| 0.05 | 70 | 45 | 50 | 70 | 80 | 100 |
| 0.01 | 40 | 65 | 50 | 50 | 50 | 65 |

TABLE 7
Accuracy and average number of observations before making the final
classification decision (in parenthesis) when varying the observable
part of the model and the length of the observed trace.

| | Length of the observed trace | | | | | | | | | |
|---|---|---|---|---|---|---|---|---|---|---|
| Observability | CABBOT | | | | | DECISION TREE | | | | |
| model | 10 | 20 | 50 | 100 | 350 | 10 | 20 | 50 | 100 | 350 |
| full | 100 | 100 | 100 | 100 | 100 | 75 | 90 | 95 | 95 | 95 |
| | (1.1) | (1.1) | (1.1) | (1.1) | (1.1) | (2.7) | (6.8) | (10.4) | (16.9) | (24.0) |
| bank | 100 | 100 | 100 | 100 | 100 | 75 | 90 | 90 | 95 | 95 |
| | (2.3) | (2.3) | (2.3) | (2.3) | (2.3) | (2.7) | (6.8) | (8.3) | (15.7) | (24.1) |
| transactions | 90 | 80 | 100 | 90 | 90 | 60 | 90 | 90 | 90 | 85 |
| | (2.2) | (7.7) | (9.8) | (16.8) | (20.2) | (0.6) | (6.0) | (8.3) | (8.1) | (39.1) |
| network | 80 | 80 | 80 | 80 | 85 | 55 | 75 | 85 | 85 | 85 |
| | (4.9) | (4.9) | (4.9) | (11.3) | (13.9) | (0.0) | (2.4) | (5.9) | (5.9) | (5.9) |

Comparison against a Non-Relational Representation: The aim of this experiment is to improve the variety of traces generated by the simulator. First, standard customers were allowed to create companies, making the traces much more diverse. Second, a comparison was made against a learning technique used in other works and suitable in terms of explainability for the purposes of AML investigation. Table 7 shows a comparison of CABBOT with a decision tree classifier. In order to use the decision tree, the traces were converted to an equivalent attribute-value representation. For all training traces, training examples were generated by observing the first action-state pair, the first two action-state pairs, and so on until the length of the trace. For each action-state pair, standard attributes used by other works for the two partial observability models were created (i.e., under the bank and full models, all these attributes were observable). Examples are average, min and max values of the previous transactions of each type (e.g. wires, or deposits), balance of accounts or number of connected accounts.

The observability models and the traces' length were varied. In general, CABBOT showed better performance both in accuracy and number of observations needed to obtain the correct classification. It may also be seen that the full and bank observability models obtain very good results, but performance degrades when using transactions or network.

Generation of Synthetic Behavior: Available AML-related datasets mostly only include transactional data. In an exemplary embodiment, a simulator that uses automated planning to generate traces that provide a richer and more realistic representation of the information a financial institution can observe about its customers and their financial transactions is provided. The simulator uses automated planning to generate the traces. The simulator allows for simulating richer money laundering behavior by allowing abnormal transfer pricing, or interleaved standard behavior. Also, the simulator incorporates a richer network structure, such as customers being companies, owned by networks of people.

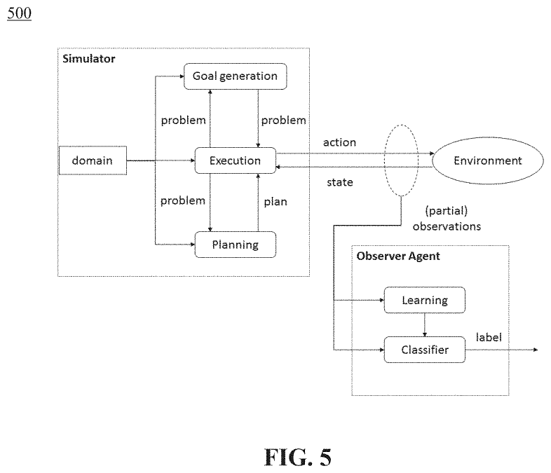

FIG. 5 is a block diagram 500 of a simulator configured to implement a method for dynamic goal-based planning and learning for simulation of anomalous activities, according to an exemplary embodiment. The block diagram 500 shows an outline of the simulator (corresponding to C) and the observer (corresponding to F). C takes actions in the environment by using a rich reasoning model that includes planning, execution, monitoring and goal generation as further described below.

Domain Model: The domain is modeled with Planning Domain Description Language (PDDL), which allows for a compact representation of planning tasks. A common domain model is defined for both behaviors (i.e., standard and criminal). The model includes: a hierarchy of types (e.g. account, company, or customer); a set of predicates and functions (Tables 1 and 2); and a set of actions (Table 3).

Different planning problems can be defined within a domain. They consist of: (1) a set of objects, such as customers, accounts, companies, and transactions; (2) an initial state that, in our case, is the same for both kinds of behavior except that it contains information on a customer being a criminal for bad behaviors; and (3) a set of goals, that is initially empty as they will be dynamically generated by the goals generation component.

Some examples of known behavior for money laundering have been modeled. Standard money laundering is composed of placement, layering and integration. Placement consists of introducing the money with illicit origin into the financial system. In an exemplary embodiment, two different ways of performing placement are implemented: depositing money directly into bank accounts, or moving digital money to standard accounts. Layering entails moving placed money into other accounts to make tracing the origin/destination of money difficult. Integration entails on using that money for standard operations. Three integration strategies have been implemented: withdrawal, paying bills, or international money transfer. All these decisions are made randomly according to some probability distributions.

Execution: At each simulation step, the execution component calls the planning component if there is a reason for planning or replanning. Reasons for replanning include: the new state is not the expected one; or goal generation has returned new goals. If there is a plan in execution, it simulates its execution in the environment. The simulator includes the possibility of defining deterministic and non-deterministic execution of actions, and the appearance of exogenous events. At each step, the execution component calls goal generation for changes in the goals or partial descriptions of states, as further described below.

The interaction with the environment also generates a trace of observations that will be used for training and test of F learning component. The trace contains a sequence of actions and states from the F viewpoint. Hence, the execution applies a filter on both so that it includes only its observable elements in the trace. Each simulation finishes after a predefined number of simulation steps (i.e., horizon) that is a parameter, or after a plan was not found in two consecutive steps in a given time bound. In an exemplary embodiment, the time bound may be set with a low value (10 seconds), since this is enough in most cases.

Goal Generation: This component allows agents to generate realistic behavior whose goals evolve over time depending on the current state of the environment. It takes as input the current problem description (i.e., state, goals and instances) and returns a new problem description. The first effect of this module is to change goals. In order to do so, two kinds of behavior have been defined by changing the goals of each type. In the case of persons doing money laundering, the simulator will dynamically generate goals corresponding to a pure bad behavior, such as committing a crime, or laundering money. But, the simulator will interleave these bad behavior goals with standard customer goals, so that the task of deciding whether some trace belongs to a bad behavior is not easy to detect. In the case of standard customer goals, the simulator would generate goals such as owning a house (or cheaper kinds of products or services), working for a company, creating a company, or making payments to a utility company. The generation of goals for both kinds of behavior is guided by some probability distributions that allow to easily change the types of traces generated.

This component can also change the state and instances. This is useful for generating new components of the state on-line. As an example, it is preferred not to include initially information about all transactions to be performed by C during the complete simulation period. Instead, the goal generation component allows the simulator to define new objects or state components as needed. So, if it generates a goal of buying a product, it could generate a new customer—the seller—her account, the product to be bought, and all the associated information in the state.

Planning: Planners take as input a domain and problem description in PDDL, and return a plan that solves the corresponding planning task. In principle, any PDDL complaint planner could be used. However, in an exemplary embodiment, extensive use is made of numeric variables (i.e., using PDDL functions). So, planners that can reason with numeric preconditions and effects should be used.

Experiments on Behavior Novelty: As a final experiment, it was desired to test the hypothesis that the learning system would be able to still correctly identify new unseen behavior, which would lead to a great advantage to AML investigation. In order to test the identification of novel behavior, 10 training instances corresponding to a specific money laundering behavior were generated (i.e., placement with cash deposits, usually called structuring) and also 10 training instances of standard customer behavior were generated. Then, 20 test instances randomly selecting good and bad behavior were generated. However, now the bad behavior used placement with digital money. So, the experiment was designed to test the ability of CABBOT to correctly classify unseen behavior. Long traces of 350 steps were used. The result is that it correctly classified all test instances (100% accuracy). But it took it more observations than before to detect it; from an average of 2.75 when it saw both kinds of placement in the training instances, to 8.3 when it only saw cash deposits in the training instances and the test where using digital. In the case of the decision tree, it also had a 100% accuracy, but the average number of observations that it required to converge to the right decision was 50.95. When the training behavior (digital placement) and test behavior (cash deposits) were reversed, equivalent results were obtained. These results are very encouraging from the point of real investigation, since the system is able to correctly classify unseen behavior from a different probability distribution.

In an exemplary embodiment, the generation and classification of behavior traces may be domain-independent, i.e., not restricted to the domain of financial transactions and potential crimes related thereto. Given some training traces obtained by observing at least two kinds of agents, a goal of this research includes learning a classifier that can differentiate among those types of agents by observing traces of their behavior. It is assumed that there may be a, usually hidden, rationale for the behavior of agents when taking actions in the environment that depends on some (again hidden) goals and the states they encounter while taking actions to achieve those goals. Further, it is also assumed that goals, states and actions can be represented using standard planning representation languages.

Previous work on sequence classification in contexts where there was no domain model and the representation of traces was a vector of features is leveraged. Some of those approaches did a manual definition of the relevant features to be used in the classification, which usually resulted in domain-dependent approaches. And none of these approaches used a relational representation of data in the form of goals, states and actions. Instead, it may be assumed that the other agents use a hidden planning model and the relevant aspects to make the classification depend on the actions executed and the related states.

Given the setup of an observer agent and a planning-execution agent, several decision-making tasks can be defined. Within this setting, most works in automated planning have focused on goal/plan recognition, where the observer has to infer the goals the planning agent is pursuing or the plan it is using to achieve some goals. Once the goals/plans are recognized, other planning-related tasks can be solved such as generating plans to stop an opponent to reach its goals or change the environment to improve the goal recognition task. Other uses of traces include learning action models or predicting the next action or sequence of actions another agent is going to perform.

Even if it has been less studied than related tasks in the context of automated planning, many real-world tasks benefit directly from this research. Some of these domains have been studied in the context of domain-dependent approaches. Examples are: predicting whether someone will buy a product from the web clicks sequence; detecting intrusions in network or stand-alone computer systems; classification of anomalous behavior in public spaces (e.g. terrorism); machines monitoring the behavior of other machines; or labeling an opponent's behavior in a game. In the case of financial applications, there are numerous examples of the use of this task such as: fraud or anti-money laundering detection; classifying malicious traders; attrition prediction; offering new services to customers; or detection of users that will complain.

In an exemplary embodiment, the following is provided: a learning technique that can classify in agents' types based on their behavior expressed in observation traces; and a domain-independent simulator of agents' behavior based on dynamic goal generation, planning and execution. The learning technique is described above as Classification of Agents' Behavior Based on Observation Traces (CABBOT). Some of the simulator features include: explicit reasoning on goals generation, modification and removal; ability to inject new instances when needed; several methods for generating goals, including a goals schedule and behavior-based random generation; exogenous events; non-deterministic execution of actions; and partial and noisy observability.

This section focuses on a general applicability to planning tasks. Therefore, the description of the techniques and the simulator are centered on the underlying planning tasks, and the experiments report on several domains. Thus, several domains are designed for this task, whose detailed description is included in the experimental section below. The domains range from a simplified terrorist domain to a service cars domain and two financial services-related domains. The results show that CABBOT can accurately classify agents in those domains.

Given an assumption that agents' rational behavior is based on the concepts of goals, states and actions, an automated planning formalism is used to describe the tasks.

Automated Planning: The standard classical Stanford Research Institute Problem Solver (STRIPS) definition of a planning task is used, augmented with numeric variables (functions). A planning task is defined as Π= [symbol] F,A,I,G [symbol] , where F is a set of boolean and numeric variables, A is a set of actions, I⊆F is the initial state and G⊆F is a set of goals. Each action a∈A is defined in terms of its preconditions (pre(a)) and effects (eff(a)). Effects can set to true the value of a boolean variable (add effects, add(a)), set to false the value of a boolean variable (del effects, del(a)), and change the value of a numeric variable (numeric effects, num(a)). The set of all states is denoted with S. A (full) state is a valuation of all the variables in F; a boolean value for all the boolean variables and a numeric value for the numeric ones. Action execution is defined as a function γ:S,A→S; that is, it defines the state that results of applying an action in a given state. It is usually defined as γ(s,a)=(s\del(a))∪add(a) if pre(a)⊆s when only boolean variables are considered. When using numeric variables, γ should also change the values of the numeric variables (if any) in num(a), according to what the action specifies; increasing or decreasing the value of a numeric variable or assigning a new value to a numeric variable. If the preconditions do not hold in s, the state does not change.

The solution of a planning task is called a plan, and it is a sequence of instantiated actions that allows the system to transit from the initial state to a state where goals are true. Therefore, a plan π= [symbol] a₁,a₂, . . . aₙ [symbol] solves a planning task Π (valid plan) if and only if ∀aᵢ∈π,aᵢ∈A, and G⊆γ( . . . γ(γ(I,a₁),a₂) . . . ),aₙ). In case the cost is relevant, each action can have an associated cost, c(aᵢ),∀aᵢ∈A and the cost of the plan is defined as the sum of the costs of its actions:

$$c ( π ) = {\sum }_{i} c ( {a}_{i} ) , ∀ {a}_{i} ∈ π .$$

The planning community has developed a standard language, Planning Domain Description Language (PDDL), that allows for a compact representation of planning tasks. Instead of explicitly generating all states of Π, a lifted representation in a variation of predicate logic is used to define the domain (predicates and actions) and the problem to be solved (initial state and goals).

Multi-Agent Framework: In this work at least two agents are considered: acting agent, C (e.g. bank customer) and observer agent, B (e.g. financial institution or bank). In order to create a realistic environment, it is considered that they have different observability of the environment. Thus, each one of them will have its own definition of a planning task, as it has already been defined in cooperative and adversarial multi-agent settings. In the case of C, its planning task can be defined as Π_{C}= [symbol] F_{C},A_{C},I_{C},G_{C} [symbol] . In the case of B, its ability to plan is not presently considered.

B has a partial (public) view of C's task. This view can be defined as Π_{B,C}= [symbol] F_{B,C},A_{B,C},I_{B,C}Ø [symbol] , where F_{B,C}⊆F_{C}, A_{B,C}⊆A_{C}, I_{B,C}⊆I_{C} and the goals are unknown, represented as Ø. It also has a partial view of the initial state and the actions; since there will be some actions executed by C, or some preconditions or effects of those actions that B will not observe. B has no observability of C's goals. This assumption contrasts with goal and planning recognition work that assumes a set of potential goals are known. In the present case, this set would amount to all possible goals that can be defined given a domain, which is infinite in most cases. Finally, regarding C rationality, C can generate optimal or sub-optimal plans.

As an example, a customer might have goals that are not observed by the financial institution, such as having committed a crime, or laundered money. Other goals will be observable only after the customer has executed actions within the financial system that might reveal them, such as having opened an account, worked for a company, made a money transfer, or withdrawn money from a bank. In relation to states, there will be information known by the customer that is not observable by the financial institution, such as how many hours the customer works, or products bought using cash. Similarly, some information will be known, such as products or services bought using financial instruments of the corresponding financial institution, or bills paid to utility companies. Finally, there will be actions performed by the customer that will not be observed by the financial institution, such as committing a crime, while others will be observable, such as making a money transfer.

Once C starts generating plans and executing the actions on those plans, B will be able to see: if the actions in A_{B,C} are executed; and the components of the state related to variables in F_{B,C}. A planning trace t_{C} is a sequence of states and actions executed by C in those states:

t_{C}=(I_{C},a₁,s₁,a₂,s₂, . . . ,sₙ₋₁,aₙ,sₙ)

where sᵢ∈S_{C},aᵢ∈A_{C}. An observation trace is also a sequence of states and actions of C from the point of view of B t_{B,C}=(I_{B,C},a′₁,s′₁,a′₂,s′₂, . . . , s′ₙ₋₁,a′ₙ,s′ₙ), where s′ᵢ∈S_{B,C},a′ᵢ∈A_{B,C}. Each state s′ᵢ corresponds to the partial observability of C's state sᵢ by B. Also, each action a′ᵢ corresponds to either an action that can be observed from C, aᵢ, or a fictitious no-op action if aᵢ cannot be observed by B. There is no actual need of requiring the states to be part of the observation; given that B has a model of C's domain, B can always reproduce the corresponding observable states, by simulating the execution of the observable actions. T_{B,C}={t_{B,C}} refers to the set of traces of agent C observed by agent B.

In the classification task, there are two C agents that the learning system will differentiate by observing their behavior traces. As an example, consider a criminal and a regular customer. It is desired to address non-trivial learning tasks. Therefore, it is assumed that there is nothing in the observable state that directly identifies one or the other type of C agent. Nor there is any difference on the observable actions between the ones that can be executed by one or the other type of C. Formally, given two different types of C, C₁ and C₂, B's observable information on both should be the same:

Π_{B,C}_{₁}=Π_{B,C}_{₂}= [symbol] F_{B,C}_{₁},A_{B,C}_{₁},I_{B,C}_{₁},Ø

[symbol]

Learning to Classify Behavior: B's main task consists of learning to classify among the different types of C (behaviors). The learning task can be defined as follows:
Given: (1) a set of classes of behavior (labels) C={C₁,C₂, . . . , Cₙ}; (2) a set of labeled observed traces T_{B,C}_{ᵢ},∀Cᵢ∈C; and (3) a partially observable domain model of each Cᵢ given by Π_{B,C}_{ᵢ}
Obtain: a classifier that takes as input a new (partial) trace t (with unknown class) and outputs the predicted class

A main requirement of CABBOT is to be domain-independent. Therefore, there is no use of any hand-crafting of features for the learning task. Another characteristic of this learning task is that it works on unbounded size of the learning examples. Traces can be arbitrarily large, as well as states within the trace and action descriptions, both in the number of different action schemas, and grounded actions. There is no a priori limit on these sizes. Using fixed-sized input learning techniques can be difficult in these cases and some assumptions are employed to handle that characteristic. Hence, only relational learning techniques are considered, and, in particular, relational instance-based approaches are preferred. Relational learning techniques have been extensively used in the past to learn control knowledge, or planning policies, among other planning tasks. In an exemplary embodiment, these techniques are used herein for this learning task.

The key parameter of these techniques is the relational distance between two traces, d:T×T→R. In order to define the distance between two traces, t₁ and t₂, there are several alternatives: 1) Compute a distance between the sets of actions on each trace. A simple, yet effective, distance function consists of using the inverse of the Jaccard similarity function as:

$${d}_{a} ( {t}_{1} , {t}_{2} ) = 1 - \frac{\vert an ( {t}_{1} ) ⋂ an ( {t}_{2} ) \vert}{\vert an ( {t}_{1} ) ⋃ an ( {t}_{2} ) \vert}$$

where an(tᵢ) is the set of actions' names in tᵢ. This distance is based on the ratio of common action names in both traces to the total number of different action names in both traces.

2) Compute distances between sequences of states differences. Given two consecutive states s₁ and s₂ in a trace, their associated difference or delta is defined so as to represent the new literals in the state after applying the action. They are defined as: δₛ_{ᵢ}_{,s}_{ᵢ₊₁}=sᵢ₊₁\sᵢ. A distance may be computed between the sets of deltas on each trace by using the Jaccard similarity function as before.

$${d}_{Δ} ( {t}_{1} , {t}_{2} ) = 1 - \frac{\vert Δ ( {t}_{1} ) ⋂ Δ ( {t}_{2} ) \vert}{\vert Δ ( {t}_{1} ) ⋃ Δ ( {t}_{2} ) \vert}$$

where Δ(tᵢ)={δₛ_{ⱼ}_{,s}_{ⱼ₊₁}|∀sⱼ,sⱼ₊₁∈tᵢ,0≤j≤n−1} is the set of deltas of a trace tᵢ. Again, only the predicate and function names are used.

3) The two previous distances only consider actions and deltas as sets. If it is desired to improve the distance metric, a frequency-based approach (i.e., equivalent to an n-grams analysis with n=1) may be used. Each trace is represented by a vector. Each position of the vector contains the number of times an observable action appears in the trace. The distance between two traces, d_{g}, is defined as the squared Euclidean distance of the vectors representing the traces. As before, a new trace is classified as the class of the training trace with the minimum distance to the new trace.

4) Instead of using only counts, the distance function can also consider actions and state changes as relational formulae and use more powerful relational distance metrics. A version of the RIBL relational distance function is adapted for a representation of traces, dᵣ, based on the different semantics of the elements of the traces with respect to generic RIBL representation of examples. Given two traces, the traces are first normalized by substitution of the names of the constants by an index of the first time they appeared within a trace. For instance, given the following action and state pair:

```

[symbol]
              create-account(customer-234,acc-
              345),
    { acc-owner(customer-
                        234,acc-345),
                        balance(acc-
                        345)=2000} [symbol]
  the normalization process would convert the trace to: [symbol]
              create-account(i1,i2),
              {acc-owner(i1,i2),
                balance(i2)=2000} [symbol]
```

This process allows the distance metric to partially remove the bias related to using different constant names in the traces. The distance dᵣ is then computed as:

dᵣ(t₁,t₂)=½(dᵣₐ(t₁,t₂)+d_{rΔ}(t₁,t₂))

i.e. as the average of the sum of dᵣₐ (distance between the actions of the two traces) and d_{rΔ} (distance between the deltas of both traces). dᵣₐ is computed as:

$${d}_{ra} ( {t}_{1} , {t}_{2} ) = \frac{1}{Z} {\sum }_{{a}_{i} ∈ a ( {t}_{1} )} {min}_{{a}_{j} ∈ a ( {t}_{2} )} {d}_{f} ( {a}_{i} , {a}_{j} )$$

where a(tᵢ) is the set of ground actions in tᵢ, d_{ƒ} is the distance between two relational formulas, and Z is a normalization factor (Z=max{|a(t₁)|,|a(t₂)|}). The normalization is performed by using the length of the longest set of actions to obtain a value that does not depend on the number of actions on each set, so distances are always between 0 and 1. d_{ƒ} is 1 if the names of aᵢ and aⱼ differ. Otherwise, it is computed as:

$${d}_{f} ( {a}_{i} , {a}_{j} ) = 0.5 - 0.5 \frac{1}{\vert arg ( {a}_{i} ) \vert} {d}_{arg} ( {a}_{i} , {a}_{j} )$$

where d_{arg}(aᵢ,aⱼ) is the sum of the distances between the arguments in the same positions in both actions. Each distance will be zero (0) if they are the same constant and one (1) otherwise. Again, the values for distances are normalized. Also, when two ground actions have the same action name, a distance of at most 0.5 is set. For instance, if l₁=create-account(i1,i2) and l₂=create-account(i3,i2),

d_{ƒ}(l₁,l₂)=0.5−0.5½(1+0)=0.25.

As a reminder, each trace contains a sequence of sets of literals that correspond to the delta of two states. Therefore, d_{rΔ} is computed as the distance of two sets of deltas of literals (Δ(t₁) and Δ(t₂)). A similar formula to the previous ones is used:

$${d}_{r Δ} ( {t}_{1} , {t}_{2} ) = \frac{1}{{Z}_{Δ}} {\sum }_{{δ}_{1} ∈ Δ ( {t}_{1} )} {min}_{{δ}_{2} ∈ ( {t}_{2} )} {d}_{r δ} ( {δ}_{1} , {δ}_{2} )$$

$$where {Z}_{Δ} = max \{ \vert Δ ( {t}_{1} ) \vert , \vert Δ ( {t}_{2} ) \vert \} , and {d}_{r δ} : \\ {d}_{r δ} ( {δ}_{1} , {δ}_{2} ) = \frac{1}{max \{ \vert {δ}_{1} \vert , \vert {δ}_{2} \vert \}} {\sum }_{li ∈ δ 1} {min}_{lj ∈ δ 2} {d}_{f} , ( {l}_{i} , {l}_{j} )$$

d_{ƒ′}(lᵢ,lⱼ)=d_{ƒ}(lᵢ,lⱼ) when the literals correspond to predicates. d_{ƒ} is used since actions and literals in the state (lⱼ,lⱼ) share the same format (i.e., a name and some arguments). However, when they correspond to functions, since functions have numerical values, a different function dₙ is used. In this case, each lᵢ will have the form ƒᵢ(argᵢ)=νᵢ. ƒ(argᵢ) has the same format as a predicate (or action) with a name ƒᵢ and a set of arguments argᵢ, so d_{ƒ} can be used on that part. The second part is the functions' value. In that case, the absolute value of the difference between the numerical values of both functions is computed and then divided by the maximum possible difference (M) to normalize:

$${d}_{n} ( {l}_{i} , {l}_{j} ) = {d}_{f} ( {f}_{i} ( {arg}_{i} ) {f}_{j} ( {arg}_{j} ) ) \times \frac{abs ( {v}_{i} - {v}_{j} )}{M}$$

Both are multiplied, since the distance on the arguments may be seen as a weight that modifies the difference in numerical values. For example, if

$${δ}_{1} = \{ acc \text{-} owner ( i 1 , i 2 ) , balance ( i 2 ) = 20 \} , \\ {δ}_{2} = \{ acc \text{-} owner ( i 1 , i 3 ) , balance ( i 3 ) = 10 \} , then$$

$${d}_{r Δ} ( {δ}_{1} , {δ}_{2} ) = \frac{1}{2} ( min \{ 0.25 , 1 \} + min \{ 1 , 0.5 \times \frac{\vert 20 - 10 \vert}{M} \} )$$

Once a distance metric between traces is obtained, an instance-based technique, such as kNN, may be used to classify a new trace according to the k traces with minimum distance, and computing the mode of those traces' classes. Since the classifier takes a trace as input, CABBOT also allows for on-line classification with the current trace up to a given simulation step. A nice property of kNN is that an explanation as to how a behavior was classified may be provided by pointing out the closest previous cases.

Referring again to FIG. 5, the components of the simulator for the planning agents are: the Execution, that takes a domain and problem description and follows a reasoning cycle that involves generating a new plan by calling Planning, executing the next action(s) from the current plan in the environment and observe the next state, and obtaining new goals or state components from Goal generation. The simulator is domain independent, except for the Goal reasoning that needs to generate behavior corresponding to at least two types of agents in the same domain.

Execution: Execution performs several tasks for some iterations: 1) If there is no plan, or there is a reason for replanning, it calls Planning to generate a new plan. Reasons for replanning include: the state received from the environment is not the expected one (i.e., it does not fully match the state predicted by the effects of the most recently action); and Goal generation has returned new goals and/or changes in the state. A standard planner may be used for replanning, but it can be substituted by replanning algorithms.

2) If there is a plan in execution, it selects the next action to execute and sends it to the environment. The environment simulates the execution of the action and returns a new state. As mentioned above, the new state can be the one defined by the effects (i.e., deterministic execution). The simulator also includes the possibility of defining non-deterministic execution of actions, as well as the appearance of exogenous events.

3) At each step, it also calls Goal generation for changes in the goals or partial descriptions of states, as further described below.

4) The interaction with the environment also generates a trace of observations that will be used for both training and testing of the learning component of B. As described above before, the trace contains a sequence of actions and states from the point of view of B. Therefore, Execution applies a filter on both so that it only includes in the trace its observable elements. Observability is defined for each domain. In an exemplary embodiment, one simplified way to define it is as the sets of lifted actions and predicates that can be observed by B. Any ground action or state literal of a lifted action or predicate on those sets will be observable. In addition, B might not see the actual executed action but another one (i.e., noisy observations). Also, it might not be able to see some of the actions even if they are in the observable set (a further aspect of partial observability).

5) Each simulation finishes after a predefined number of simulation steps (horizon) that is a parameter, or after a plan has not been found in a given time bound. The time bound may be set with a relatively low value (i.e., 10 seconds), since this is enough in the experimental domains used in most cases.

Goal generation: This component allows agents to generate believable behavior whose goals evolve over time depending on the current state of the environment. It takes as input the current problem description (i.e., state, goals and instances) and returns a new problem description. The first effect of this module is to change goals. In order to do so, two kinds of behavior have been defined for each domain by changing the goals of each type of behavior. For instance, in the case of a terrorist domain, two types of agents are defined: regular person and terrorist. The regular person would generate goals of going from one place to another. When the simulator has achieved the previous goal (i.e., moving to a place), this module will generate a new goal of being somewhere else randomly chosen. However, randomly, the knapsack that it carries might fall down and be forgotten by the person. So, when the person notices that it does not carry the knapsack, it will generate a new goal to hold it again. In the case of the terrorist, this module will randomly generate the goal of not carrying the knapsack. Further, even if it knows that it is not carrying the knapsack, it will not generate as a goal to carry it again, as in the case of the regular person. As a reminder, the observer does not know the goals of the other agent.

This module can also change the problem state and instances. This is useful for generating new components of the state on-line, as with partial observability of a rich environment. Suppose it is desired to simulate an open environment where agents wander around and go to places that were not defined originally in the initial problem description. One alternative consists of defining a huge state (and associated instances) in the initial problem description to account for the whole map. This forces the planner to generate many more instantiations than the ones actually needed to plan in the first simulation steps. The ability of Goal generation to change the state and instances descriptions allows the simulator to generate new parts of the world, or even remove visited ones if not further needed, on the fly, thus making the process more efficient and dynamic.

Planning: In an exemplary embodiment, the simulator operates in a domain-independent setting. Therefore, domain and problem models are specified in PDDL. Thus, any PDDL-compliant planner could be used for this purpose. In particular, some domains entail extensive use of numeric variables (i.e., using PDDL functions). So, planners that can reason with numeric preconditions and effects are preferred. As expected, planners take as input a domain and problem description in PDDL, and return a plan that solves the corresponding planning task. All of these planners generate sub-optimal solutions.

Experiments—Experimental setting: Due to the lack of existing domains in the planning community that address the task of behavior classification from planning-execution traces, several new domains have been defined:

1) Terrorist: a domain where people move around a grid that represents an open space (i.e., station, airport, square, etc.) holding a knapsack. Regular people might accidentally drop the knapsack (i.e., with probability 0.2), but they try to recover it when they find out. Terrorists drop the knapsack (i.e., with probability 0.4) and leave it there. The model is composed of three actions (i.e., move, drop and take) and four predicates. The goal is to classify as either terrorist or regular behavior from the observed traces. There is full observability in this domain, given that all actions and states are observable, and cannot differentiate between the two types of agents.

2) Service cars: some vehicles move around the streets of a city network. The model comprises seven actions and seven predicates. Actions include: moving from one street section to another connected one, boarding and unboarding a vehicle, and stopping a vehicle and moving it again. The classification goal is to distinguish the vehicles that are particular cars from the service cars (i.e., taxis or equivalent). All actions and predicates are observed, except for two predicates—whether a driver of a car owns the car, and whether or not there is a passenger inside a service car. There are two boarding actions that vary based on the type of vehicle, but the observer cannot differentiate between the two. The same applies to debark actions. The probability that a new goal related to moving someone appears is 0.6 in the case of service cars, while the probability that a new goal related to moving the owner appears is 0.2 in case of private cars.

Customer journeys (journey): customers access the mobile application of a bank and perform several operations. The model comprises 22 actions, 24 predicates and 2 functions. Actions include: logging in, checking or changing diverse information on their accounts, or performing financial operations. The classification goal is to distinguish between customers that are active with the mobile application from the ones that do not use the mobile application. The observable actions and predicates are equal for both types of customers. The main difference is the probability of a goal appearing at some point (i.e., a need of a customer of performing some operation). Active customers will have a higher probability than non-active ones.

Customer journeys (digital-journey): another version of the previous domain, where the task consists of classification between digital users and traditional users. In terms of behavior, digital users have a higher probability of performing digital-based operations, such as quick payments, and traditional users tend to have a lower probability on those operations, but a higher probability on traditional operations, such as paying bills).

Anti-money laundering (AML): customers of a financial institution perform operations such as money transfers, payments, or deposits. In the meantime, in a manner that is not observable by B, these customers are either involved in criminal activities, or are regular customers. The challenge in this domain consists of characterizing the type of behavior from observations related to standard activities with the bank. The model comprises 33 actions, 37 predicates and 12 functions. Actions include: criminal activities, getting a job, getting a payroll, or making financial operations. The classification goal consists of distinguishing between money laundering individuals and regular individuals. Observability is restricted to the information that a bank can have on a given customer. Therefore, predicates as someone being a criminal or getting dirty money are not observable, while predicates related to making transactions and opening accounts are observable. An attempt has been made to make this domain rich in terms of the different traces generated by the simulator. Therefore, several probability distributions are defined that affect issues such as probabilities of selecting different money laundering strategies by criminals, or buying different kinds of items by criminals and regular customers.

For each domain, each experiment includes a random generation of 10 traces of each type of behavior for training and 20 for testing, where classes are uniformly randomly selected. The accuracy of the prediction is measured. A k value of k=1 has been used for the experiments, given that good result have previously been obtained with that value. The following parameters have been varied to see the impact they have on the results: 1) Length of the traces (i.e., simulation horizon): The experiments used the values of 5, 10, 20, 50 and 100, with a default value of 50. 2) Similarity function: The defined values of dₐ, d_{Δ}, d_{g} and dᵣ have been used, with a default value of dᵣ. 3) Probability-goal-appears: A probability that a set of goals appear at a given time step is defined. Once a set of goals appears, it might take several time steps to execute the plan to achieve all goals. In the meantime, no new goals are generated, though the simulator is ready to work with that case too. The values of 1.0, 0.8, 0.5, 0.1, 0.05 and 0.01 are used, with a default value of 1.0.

Results: Table 8 below shows the results for the journey domain. In this domain, the behavior depends on the probability of a goal arriving for both types of customers: active and non-active. Those probabilities have been varied in order to analyze how their values affect the accuracy of CABBOT. It may be observed that when the difference between the two probabilities gets smaller, the behavior becomes more similar, in terms of activity level of customers, and accuracy of classification correspondingly degrades. In the extreme, when the two probabilities are equal—i.e., the (0.5, 0.5) case—the classification accuracy is equivalent to a random classification (i.e., 0.55). The combinations [symbol] 0.8,0.01 [symbol] (named journey-B for bigger difference) and [symbol] 0.5,0.1 [symbol] (named journey-S for smaller difference) are used for the remaining comparisons.

TABLE 8
Classification accuracy in the customer journey domain
varying the probability of appearing goals for the
two kinds of customers, active and non-active.

| | Length of traces | | | | |
|---|---|---|---|---|---|
| Domain | 5 | 10 | 20 | 50 | 100 |
| terrorist | 0.60 | 0.90 | 0.95 | 1.00 | 1.00 |
| service car | 0.60 | 0.95 | 1.00 | 1.00 | 1.00 |
| journey-B | 1.00 | 0.95 | 0.85 | 0.80 | 0.95 |
| journey-S | 0.45 | 0.80 | 0.60 | 0.95 | 0.85 |
| digital-journey | 0.75 | 0.85 | 0.90 | 1.00 | 1.00 |
| AML | 1.00 | 1.00 | 1.00 | 0.90 | 0.95 |

The next results of the experiments are presented in Table 9 below. Rows represent the domains, and the columns are different lengths of the traces (horizons). The values correspond to the accuracy of CABBOT fixing all other parameters to their default values. The results show that CABBOT is able to correctly classify behavior traces in a high percentage of cases. It is observed that neither a high number of traces nor lengthy traces is required to obtain good results. As expected, CABBOT had less accuracy in shorter traces, since it has observed a lesser number of actions/states, so it is harder to correctly classify the behavior. In the case of the journey domain, the longer traces allow for more goals to appear in the case of non-active customers, making the classification harder. Also, as observed before, the results with a smaller difference of probability values are worse than with a bigger difference, especially in the case of shorter traces' lengths.

TABLE 9
Classification accuracy in different domains
varying the length of the trace.

| | Length of traces | | | | |
|---|---|---|---|---|---|
| Domain | 5 | 10 | 20 | 50 | 100 |
| terrorist | 0.60 | 0.90 | 0.95 | 1.00 | 1.00 |
| service car | 0.60 | 0.95 | 1.00 | 1.00 | 1.00 |
| journey-B | 1.00 | 0.95 | 0.85 | 0.80 | 0.95 |
| journey-S | 0.45 | 0.80 | 0.60 | 0.95 | 0.85 |
| digital-journey | 0.75 | 0.85 | 0.90 | 1.00 | 1.00 |
| AML | 1.00 | 1.00 | 1.00 | 0.90 | 0.95 |

Table 10 below shows the results when the similarity function is varied. As may be seen, the accuracy is perfect in most cases for all domains except for the customer journeys domain. Even if the intention when generating the two kinds of behavior was to include slight differences, the learning system is able to detect those by using the different similarity functions. In the case of the journey domain, it may be seen that the actions-based distance obtains better results than the one based on comparing goals. Since this domain has many different goals, when goals appear the traces differ more on the goals than on the actions achieving the goals. Also, the similarity function used does not affect much in this domain to differentiate between bigger (B) or smaller (S) probability differences.

TABLE 10
Classification accuracy in different domains
varying the similarity function.

Similarity function

| Domain | dₐ | d_{Δ} | d_{g} | dᵣ |
|---|---|---|---|---|
| terrorist | 1.0 | 1.0 | 0.95 | 0.9 |
| service car | 0.5 | 1.0 | 1.0 | 1.0 |
| journey-B | 1.0 | 0.5 | 1.0 | 0.80 |
| journey-S | 0.75 | 0.5 | 1.0 | 0.95 |
| digital-journey | 1.0 | 0.95 | 1.0 | 1.0 |
| AML | 1.0 | 1.0 | 1.0 | 1.0 |

CABBOT can make on-line classification of traces as soon as observations are made. Table 11 below shows the average number of observations before making the final classification decision when varying the similarity function. While in the AML and service car domains, it takes a small number of steps to make the final decision, the number of steps required in the other two domains is higher. This is especially true in the case of the journey domain for the same reasons discussed above; i.e., goals could take some time to appear.

TABLE 11
Average number of observations before making the final classification
decision when varying the similarity function in several domains.

Similarity function

| Domain | dₐ | d_{Δ} | d_{g} | dᵣ |
|---|---|---|---|---|
| terrorist | 4.2 | 6.4 | 26.4 | 15.9 |
| service car | 0.0 | 2.9 | 26.2 | 0.7 |
| journey-B | 15.9 | 7.3 | 17.9 | 2.3 |
| journey-S | 25.0 | 25.0 | 16.4 | 11.1 |
| digital-journey | 2.8 | 10.6 | 10.55 | 5.9 |
| AML | 2.3 | 1.4 | 5.25 | 1.6 |

Table 12 below shows the results when the probability of partial observability is varied. It may be seen that when the probability of making an observation at a given time step decreases, so does the accuracy of the learning system, and correspondingly, the number of steps it takes the learning system to converge to the final classification increases. In the extreme, when the probability is 0.01 for a length of history of 50, the traces will at most consist of one or two elements, so classifying the traces becomes a hard task as shown by the low probabilities. The rate at which the accuracy decreases varies across domains. In the case of AML, digital-journey and journey-B domains, there is a slow decrease in accuracy. In the other three domains, the drop in accuracy is more acute starting at even a probability of observation of 0.5 in the terrorist domain.

TABLE 12
Classification accuracy in different domains varying
the probability of partial observability.

Probability of partial observations

| Domain | 1.0 | 0.5 | 0.1 | 0.01 |
|---|---|---|---|---|
| terrorist | 0.95 | 0.45 | 0.5 | 0.5 |
| service car | 1.0 | 1.0 | 0.85 | 0.45 |
| journey-B | 0.9 | 0.9 | 1.0 | 0.6 |
| journey-S | 0.85 | 0.85 | 0.8 | 0.45 |
| digital-journey | 0.9 | 0.75 | 0.55 | 0.45 |
| AML | 1.0 | 0.9 | 0.8 | 0.35 |

Table 13 below shows the results when the probability of an execution failure of individual action (i.e., degree of non-determinism) is varied. When an action fails, it stays in the same state. Since the length of the history is 50 steps, even if some actions fail, CABBOT is still getting enough observations to make accurate classifications.

TABLE 13
Classification accuracy in different domains varying the probability
of individual action execution failure. In parenthesis, the number
of steps until it converges to the final decision.

| | Probability of execution failure | | |
|---|---|---|---|
| Domain | 0.0 | 0.2 | 0.4 |
| terrorist | 0.95 | 0.9 | 0.8 |
| service car | 1.0 | 1.0 | 1.0 |
| journey-B | 0.9 | 0.95 | 0.95 |
| journey-S | 0.9 | 0.95 | 0.8 |
| digital-journey | 0.7 | 0.85 | 0.75 |
| AML | 1.0 | 1.0 | 1.0 |

Related work: Given some sequence of events, there have been several learning tasks defined: sequence prediction (i.e., what the next step is going to be); sequence generation (i.e., learning to generate new sequences, e.g. simulation); sequence recognition (i.e., determine whether the sequence is legitime or belongs to a given type); sequential decision making (i.e., how to make decisions over time, e.g. planning). The present disclosure deals with sequence recognition or classification.

This task has been addressed by using different types of techniques based on features, distances or models. Features can be the presence or frequency of k-grams for all grams of size k. Model-based assumes an underlying probabilistic model and learns the parameters (i.e., Naive Bayes, Hidden Markov Model (HMM), etc.). In an exemplary embodiment, the number of symbols in the alphabet may be huge (i.e., if groundings), so computing conditional probabilities is intractable, or may be very small (i.e., action schemas) and probably not useful. Otherwise, there would have to be a reliance on domain knowledge to know, for instance, that the transaction amounts (i.e., not part of the actions) are relevant, or the sum of amounts of several consecutive transactions. So, a distances-based approach has been used. The learning task is also related to detecting anomalous behavior or outliers detection, where the techniques are the same ones. An important difference with respect to conventional approaches is that the definition of traces has been very simplistic in most cases: small number of action labels; no representation of state nor goals; and relational data is not addressed. From the point of view of classical automated planning, there has been related work on goal/plan recognition. However, in an exemplary embodiment, the task is not about predicting the goal/plan, but about classifying a given behavior in a set of behavior classes.

Accordingly, with this technology, an optimized process for dynamic goal-based planning and learning for simulation of anomalous activities is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for detecting an anomaly in human behavior, the method being implemented by at least one processor, the method comprising:
receiving, by the at least one processor, information that relates to a behavior of a person;
determining, by the at least one processor, at least one behavior trace based on the received information; and
classifying, by the at least one processor, each of the determined at least one behavior trace into a respective category from among a predetermined plurality of behavioral categories,
wherein the at least one behavior trace comprises a sequence of behavioral states and actions performed by the person in response to each respective behavioral state.

2. The method of claim 1, wherein the information that relates to the behavior of the person includes information that relates to at least one financial transaction executed by the person.

3. The method of claim 1, wherein the determining of the at least one behavior trace comprises applying a relational instance-based learning algorithm to the received information and obtaining information that indicates the at least one behavior trace as an output of the relational instance-based learning algorithm.

4. The method of claim 1, wherein the classifying includes using at least one machine learning algorithm to compare the determined at least one behavior trace with historical behavior trace data to determine the respective category.

5. The method of claim 4, wherein the predetermined plurality of behavioral categories includes a first category that corresponds to behaviors that indicate an intention to commit a crime and a second category that corresponds to behaviors that indicate standard non-criminal activity.

6. The method of claim 1, further comprising analyzing each of the determined at least one behavior trace to determine a potential intended goal of the person.

7. The method of claim 6, wherein the analyzing includes determining whether the determined at least one behavior trace indicates an increased probability of behavior that includes a financial crime.

8. The method of claim 7, wherein the financial crime includes at least one from among a money laundering crime, a fraud, and a cyber-crime.

9. A computing apparatus for detecting an anomaly in human behavior, the computing apparatus comprising:
a processor;
a memory; and
a communication interface coupled to each of the processor and the memory,
wherein the processor is configured to:
receive, via the communication interface, information that relates to a behavior of a person;
determine at least one behavior trace based on the received information; and
classify each of the determined at least one behavior trace into a respective category from among a predetermined plurality of behavioral categories,
wherein the at least one behavior trace comprises a sequence of behavioral states and actions performed by the person in response to each respective behavioral state.

10. The computing apparatus of claim 9, wherein the information that relates to the behavior of the person includes information that relates to at least one financial transaction executed by the person.

11. The computing apparatus of claim 9, wherein the processor is further configured to determine the at least one behavior trace by applying a relational instance-based learning algorithm to the received information and obtaining information that indicates the at least one behavior trace as an output of the relational instance-based learning algorithm.

12. The computing apparatus of claim 9, wherein the processor is further configured to use at least one machine learning algorithm to compare the determined at least one behavior trace with historical behavior trace data to determine the respective category.

13. The computing apparatus of claim 12, wherein the predetermined plurality of behavioral categories includes a first category that corresponds to behaviors that indicate an intention to commit a crime and a second category that corresponds to behaviors that indicate standard non-criminal activity.

14. The computing apparatus of claim 9, wherein the processor is further configured to analyze each of the determined at least one behavior trace to determine a potential intended goal of the person.

15. The computing apparatus of claim 14, wherein the processor is further configured to determine whether the determined at least one behavior trace indicates an increased probability of behavior that includes a financial crime.

16. The computing apparatus of claim 15, wherein the financial crime includes at least one from among a money laundering crime, a fraud, and a cyber-crime.

17. A non-transitory computer readable storage medium storing instructions for detecting an anomaly in human behavior, the storage medium comprising executable code which, when executed by a processor, causes the processor to:
receive information that relates to a behavior of a person;
determine at least one behavior trace based on the received information; and
classify each of the determined at least one behavior trace into a respective category from among a predetermined plurality of behavioral categories,
wherein the at least one behavior trace comprises a sequence of behavioral states and actions performed by the person in response to each respective behavioral state.

18. The storage medium of claim 17, wherein the information that relates to the behavior of the person includes information that relates to at least one financial transaction executed by the person.

19. The storage medium of claim 17, wherein the executable code is further configured to cause the processor to apply a relational instance-based learning algorithm to the received information and obtain information that indicates the at least one behavior trace as an output of the relational instance-based learning algorithm.

20. The storage medium of claim 17, wherein the executable code is further configured to cause the processor to analyze each of the determined at least one behavior trace to determine a potential intended goal of the person.
